(19) United States
(12) Patent Application Publication
(10) Pub. No.: US 2013/0191021 A1
(43) Pub. Date: Jul. 25, 2013

(54) Trackback Electronic Device

(71) Applicants: Richard S. Slevin, Los Altos Hills, CA (US); Margarita Kovats Slevin, Los Altos Hills, CA (US)

(72) Inventors: Richard S. Slevin, Los Altos Hills, CA (US); Margarita Kovats Slevin, Los Altos Hills, CA (US)

(21) Appl. No.: 13/744,360

(22) Filed: Jan. 17, 2013

Related U.S. Application Data
(60) Provisional application No. 61/587,573, filed on Jan. 17, 2012.

(51) Int. Cl. G01C 21/00

(52) U.S. Cl. CPC G01C 21/00
USPC 701/487; 701/526; 701/522

(57) ABSTRACT

A system and method for identification of a particular one device from an array of networked devices. Each of the devices are individually addressable by a controller on the network, and a technician preferably identifies a particular one device by use of a handheld remote control. Pointing one of transmitter/receiver pair at a device including the complementary component allows remote disambiguation based upon ranging and signal strength, particularly when using a pair of orthogonal antennas to discriminate and confirm which particular device is being pointed to by the remote. Optional confirmation helps improve identification robustness, and then the properly identified device may be configured/commissioned.

### CROSS REFERENCE TO RELATED APPLICATIONS

This application claims benefit of U.S. Provisional Application No. 61/587,573 filed 17 Jan. 2013, the contents of which are hereby expressly incorporated by reference in its entirety for all purposes.

### BACKGROUND OF THE INVENTION

The present invention relates generally to personal positioning systems, and more specifically, but not exclusively, to a portable electronic device to enable retracking a path.

When hiking, it is well-known to employ a compass as an aid to direction finding and position location. It is increasingly common to employ electronic devices that access a global positioning system (GPS) or other positioning system to establish a location for the user of the device. A user is able to the GPS of the electronic device to provide distance and direction when the user moves from point A to point B. Additionally, when returning to point A from point B, the GPS is also able to provide distance and direction. However a system like this is not adequate in many situations to enable the user to retrace their path when returning to point A. In certain environments, slight deviations in turning can result in the user coming upon impassable obstacles that were not previously encountered.

What is needed is a system and method for providing turn-by-turn directions for an inbound path that retraces an outbound path.

### BRIEF SUMMARY OF THE INVENTION

Disclosed is a system and method for providing turn-by-turn directions for an inbound path that retraces an outbound path. A multi-function device including path-retrace referred to herein as trackback.

The following summary of the invention is provided to facilitate an understanding of some of technical features related to turn-by-turn tracking and path retracing, and is not intended to be a full description of the present invention. A full appreciation of the various aspects of the invention can be gained by taking the entire specification, claims, drawings, and abstract as a whole. The present invention is applicable to other devices other than wrist-worn devices and to other implementations other than hiking, hunting, running, camping, urban hiking, swimming, biking, tracking kids and/or parents.

A portable trackback compass, including a portable housing; a navigation system, coupled to the portable housing, configured to receive a plurality of navigation signals and determine a location of the portable housing responsive to the plurality of navigation signals; an orientation detector, coupled to the housing, configured to assert a turn signal when a directional orientation of the housing changes; a user-interface providing a plurality of navigation queues configured to direct a user along a course; and a controller, coupled to the orientation detector, to the navigation system, and to the user-interface, the controller including a memory with the controller configured to record a journey including a plurality of serial ordered path segments into the memory, the journey having an initial location and terminal location with each the path segment having a beginning location and an ending location and collectively defining the journey with the path segments arranged in a forward order, each the location of the path segments determined when the turn signal is asserted; wherein the controller is further configured to reverse the journey and provide the plurality of navigation queues with the course extending from the terminal location towards the initial location along the path segments in a reverse order.

A trackback method, including a) recording a plurality of path segments of a journey automatically in a forward order into a memory of a portable electronic device, an ending location of a current path segment and a beginning location of a next path segment determined responsive to an orientation change signal; b) asserting automatically the orientation change signal each time an orientation direction of a user changes; and c) providing the user with a plurality of navigation queues reversing the journey along the plurality of recorded path segments in a reverse order.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a first trackback compass incorporated into a wrist-worn device;

FIG. 2 illustrates a second trackback compass incorporated into a wrist-worn device;

FIG. 3 illustrates a third trackback compass incorporated into a wrist-worn device; and

FIG. 4 illustrates intercommunication between a pair of multifunction devices, such as shown in FIG. 3.

### DETAILED DESCRIPTION OF THE INVENTION

Embodiments of the present invention provide a system and method for providing turn-by-turn directions for an inbound path that retraces an outbound path. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

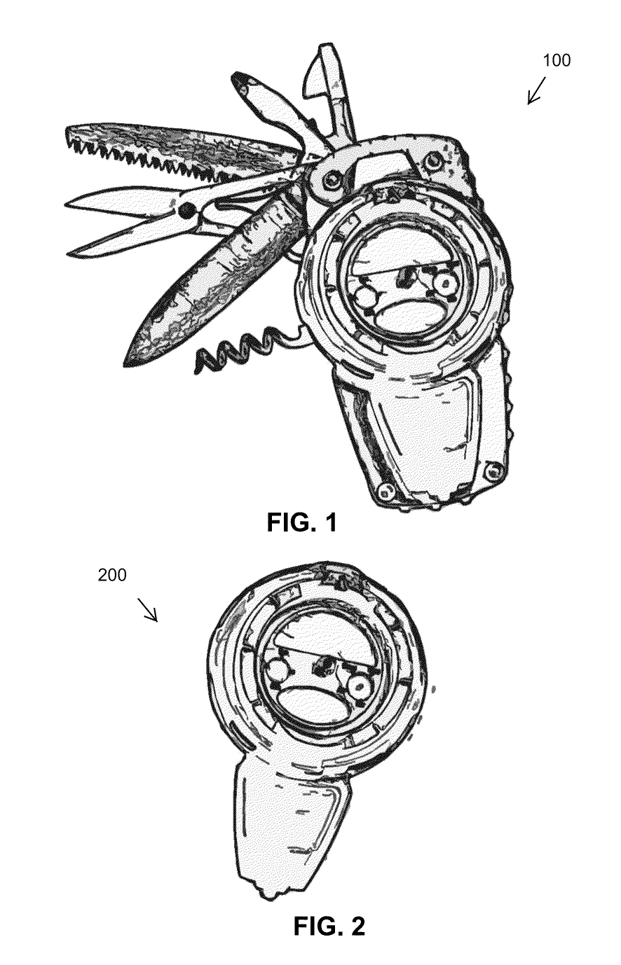

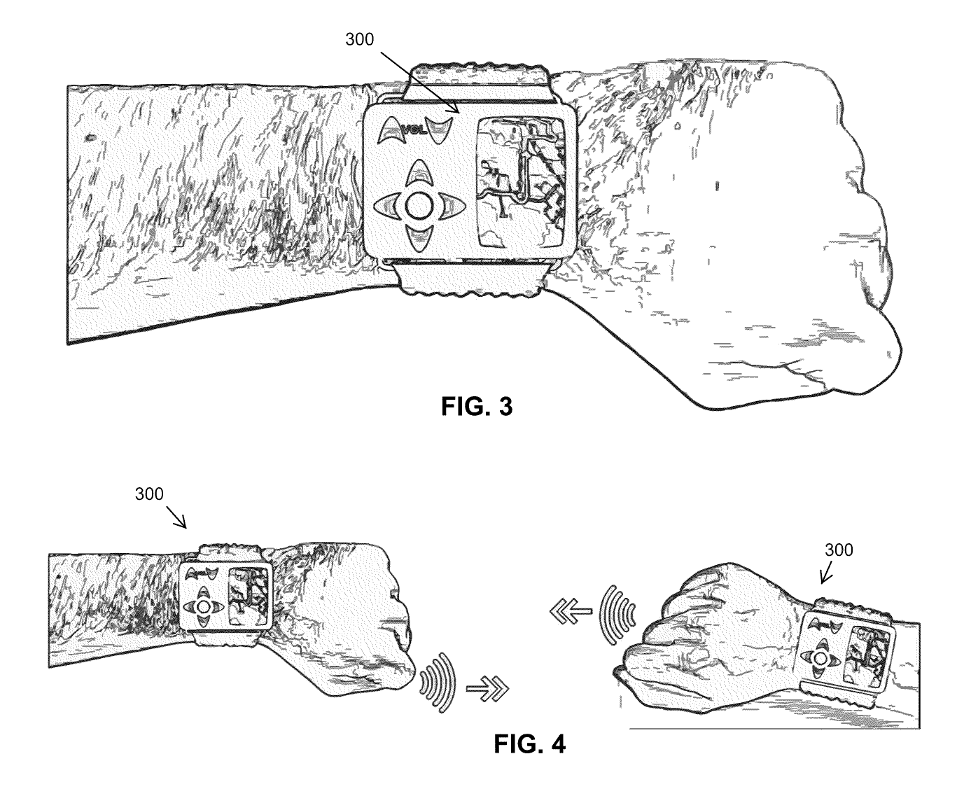

FIG. 1-FIG. 3 illustrate different multi-function devices: FIG. 1 illustrates a first trackback compass 100 incorporated into a wrist-worn device, FIG. 2 illustrates a second trackback compass 200 incorporated into a wrist-worn device, and FIG. 3 illustrates a third trackback compass 300 incorporated into a wrist-worn device. Each multi-function device: includes an electronic portion having a microprocessor accessing instructions and data from a memory and operating an electronic display; provides turn-by-turn directions to return a user the way they came using GPS with way point tracking and a compass; and uses an accelerometer to detect when a turn is made (GPS-only units give direction and distance but don't account for the landscape/terrain).

First trackback compass 100 includes, in addition to the electronic portion, multiple tools and a lighter compartment (not shown). Additional features of first trackback compass 100 includes: Barometer, Altimeter, Time, Day/Date, Alarm, Stopwatch, ultrabright flashlight, Multiple Swiss army knife type tools: Phillips and flathead screwdriver, Cutting blade, Scissors, Saw, Caplifter, Can opener, Cork screw, and includes a design with decreased battery usage.

Second trackback compass 200 includes, in addition to the electronic portion, a clip for pepper spray and the like (not shown). Additional features of first trackback compass 100 includes: Barometer, Altimeter, Time, Day/Date, Alarm, Stopwatch, Pedometer, Calorie Counter, Distance Travelled, Ultrabright Flashlight, and includes a design with decreased battery usage.

Third trackback compass 300 optionally includes the features and components described in connection with the other trackback compasses. It provides a large display and a user interface (e.g., volume and Input/Output).

FIG. 4 illustrates intercommunication between a pair of multifunction devices, such as shown in FIG. 3. A trackback compass as described herein may include intercommunication features (e.g., walkie-talkie) or data transmission to allow voice and data communications, as well as exchanging information to enable a user to locate the other. For a walkie-talkie feature, it could include communication to range: 5 to 7 km (FRS) RF. The intercommunicating devices allow tracking and talking to others within range; gives a distance and a direction of others with the same device, and is wearable and water-resistant.

In operation, a trackback compass device uses its accelerometers, compass, and GPS to record both an overall journey, but also specific turns, as the user moves from point A to point B. The trackback compass is thereafter able to enable the user to retrace their specific path when moving from point B to point A. In the intercommunication system illustrated in FIG. 4, one or more of the devices participating in the communication may transmit stored turn-by-turn coordinates to provide one mechanism for users to locate another. The system includes options to provide a shortest-path to a closest segment of the transmitted turn-by-turn path information or the system monitors position and when a user intersects a segment of the transmitted turn-by-turn path information, the system notifies the user and provides an option of following the transmitted path.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A portable trackback compass, comprising:
a portable housing;
a navigation system, coupled to said portable housing, configured to receive a plurality of navigation signals and determine a location of said portable housing responsive to said plurality of navigation signals;
an orientation detector, coupled to said housing, configured to assert a turn signal when a directional orientation of said housing changes;
a user-interface providing a plurality of navigation queues configured to direct a user along a course; and
a controller, coupled to said orientation detector, to said navigation system, and to said user-interface, said controller including a memory with said controller configured to record a journey including a plurality of serial ordered path segments into said memory, said journey having an initial location and terminal location with each said path segment having a beginning location and an ending location and collectively defining said journey with said path segments arranged in a forward order, each said location of said path segments determined when said turn signal is asserted;
wherein said controller is further configured to reverse said journey and provide said plurality of navigation queues with said course extending from said terminal location towards said initial location along said path segments in a reverse order.

2. The portable trackback compass of claim 1 wherein said navigation system includes a receiver for a global positioning system, wherein said plurality of navigation signals include broadcast signals from a plurality of global positioning satellites.

3. The portable trackback compass of claim 1 wherein said orientation detector includes an accelerometer.

4. The portable trackback compass of claim 2 wherein said orientation detector includes an accelerometer.

5. The portable trackback compass of claim 1 further comprising:
a transmitter, coupled to said controller, configured to transmit wirelessly said plurality of path segments to a receiver remote from said housing.

6. A trackback method, comprising:
a) recording a plurality of path segments of a journey automatically in a forward order into a memory of a portable electronic device, an ending location of a current path segment and a beginning location of a next path segment determined responsive to an orientation change signal;
b) asserting automatically said orientation change signal each time an orientation direction of a user changes; and
c) providing said user with a plurality of navigation queues reversing said journey along said plurality of recorded path segments in a reverse order.
